(19) United States
(12) Patent Application Publication
(10) Pub. No.: US 2020/0316655 A1
(43) Pub. Date: Oct. 8, 2020

(54) APPARATUS FOR HEATING LIQUID

(71) Applicant: Nilfisk A/S, Broendby (DK)

(72) Inventors: Erik Kristensen Worm, Nibe (DK); Mads Glavind, Hobro (DK); Leif Christensen, Hadsund (DK)

(21) Appl. No.: 16/837,697

(22) Filed: Apr. 1, 2020

(30) Foreign Application Priority Data
Apr. 2, 2019 (EP) 19166709.6

(51) Int. Cl. B08B 3/10; F24H 1/16; F24H 8/00; F24H 1/08; B08B 3/02

(52) U.S. Cl. CPC B08B 3/10; F24H 1/165; B08B 3/02; F24H 1/08; F24H 8/00

(57) ABSTRACT

A liquid heating apparatus includes a top portion with a burner unit, a coil, an external housing, and an internal housing. The burner unit is arranged to burn a fuel so as to generate a downward directed flame. The coil includes first and second layers of windings. The internal housing is arranged within the external housing. The apparatus is in a substantially upright position during operation. A compartment between the internal housing and the external serves as a first liquid reservoir. The flame from the burner unit is peripherally contained by an inner part of the first layer of windings of the coil. The first layer of windings is configured to direct the flame or exhaust gases downwards. The flame or exhaust gases are redirected such that the they contact all of the second layer of windings, the internal housing inner wall, and the first layer of windings

CROSS-REFERENCE TO RELATED APPLICATION(S)

This application claims priority to European Patent Application No. 19166709.6, filed on Apr. 2, 2019 entitled “Apparatus for Heating Liquid” by Erik Kristensen Worm, Mads Glavind, and Leif Christensen.

### BACKGROUND

In general, the present disclosure relates to an energy-efficient apparatus and method for heating of a flowing liquid, such as water. In particular, the present disclosure relates to an apparatus for heating liquid by means of a fuel burner, e.g. for use in a hot water high pressure cleaner. When heating a flowing liquid (e.g. by a diesel burner) in a high-pressure cleaning or washing device, high-energy efficiency can be essential. Due to environmental protection considerations, restrictions on such devices are becoming more and more strict.

### SUMMARY

A liquid heating apparatus includes a top portion with a burner unit, a coil, an external housing, and an internal housing. The burner unit is arranged to burn a fuel so as to generate a downward directed flame. The coil is arranged for transporting the liquid between a coil inlet and a coil outlet. The coil includes first and second layers of windings. The second layer of windings are arranged around the first layer of windings. The internal housing is arranged at least partially within the external housing. The apparatus is arranged to be in a substantially upright position during operation. The coil is arranged inside the internal housing. A compartment between the internal housing and the external serves as a first liquid reservoir such that the liquid surrounds at least a part of the internal housing. The first liquid reservoir includes an inlet connected to the liquid inlet and an outlet connected to the coil inlet. The flame from the burner unit is peripherally contained by an inner part of the first layer of windings of the coil. The first layer of windings is configured to direct the flame or exhaust gases downwards towards a bottom portion of the internal housing. The flame or exhaust gases are redirected from the bottom portion towards a space between the first layer of windings and an inner wall of the internal housing so as to allow the flame or exhaust gases contact the second layer of windings, the inner wall of the internal housing, and the first layer of windings.

A method for heating a liquid received from a liquid inlet to a liquid outlet includes providing the burner unit arranged to burn a fuel so as to generate a flame. A coil is arranged for transporting the liquid between a coil inlet and a coil outlet. The coil includes a first and a second layer of windings with the first layer of windings arranged around the first layer of windings. The coil outlet is connected to the liquid outlet. An external housing and an internal housing are provided. The coil is arranged inside the internal housing. The internal housing is arranged at least partly inside the external housing thereby forming a liquid reservoir arranged to receive liquid from the liquid inlet. The flame is directed toward a bottom portion of the internal housing. The flame or exhaust gasses are redirected from the bottom portion of the internal housing toward a space between an outer part of the first layer of windings and an inner wall of the internal housing. In so doing, the flame or exhaust gasses are allowed to contact all of the first layer of windings, the second layer of windings, and the inner wall of the internal housing. A flow of liquid is provided from the liquid reservoir to the coil so as to continuously heat flowing liquid in response to the combustion of fuel.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIGS. 1a, 1b, 1c, and 1d are cut section side views of two embodiments of a liquid heating apparatus.

FIG. 2 is a trimetric view of the liquid heating apparatus.

FIG. 3 is a schematic drawing illustrating a cut side view of another embodiment of the liquid heating apparatus.

FIGS. 4-8 are schematic drawings illustrating cut side views of different embodiments of the liquid heating apparatus.

FIG. 9 is a schematic of the flow of liquid through another embodiment of the liquid heating apparatus.

FIG. 10 is a flow-chart of a method of heating a liquid with the liquid heating apparatus.

While the above-identified figures set forth one or more embodiments of the present disclosure, other embodiments are also contemplated, as noted in the discussion. In all cases, this disclosure presents embodiments by way of representation and not limitation. It should be understood that numerous other modifications and embodiments can be devised by those skilled in the art, which fall within the scope and spirit of the principles of the disclosure. The figures may not be drawn to scale, and applications and embodiments of the present disclosure may include features and components not specifically shown in the drawings.

### DETAILED DESCRIPTION

Existing high-pressure cleaners with built-in heaters can be large, bulky, and can spend vast amounts of energy on heating the flowing water to a desired temperature, for optimal cleaning capabilities. Integrated heat exchangers tend to become very hot, limiting the selection of materials available for manufacturing, which in turn increases manufacturing costs and the cost of assembly. Due to the hot surface of the heat exchanger, the heat exchanger can require extra space in order to integrate with compact portable devices, since certain temperature sensitive components may need to be mounted a distance away from the heat exchanger. A further problem, when pressurizing water using an electric pump, is the increased oxidizing capabilities of heated water, which tends to disintegrate parts within a mechanical pump at an accelerated pace. The solutions presented herein limit this issue by precisely controlling the temperature of the water flowing from the liquid reservoir to the coil inlet through an optional mechanical pump.

Hence, an improved apparatus and method of heat exchanging would be advantageous, and in particular a more energy efficient and/or reliable heating apparatus would be advantageous. In particular, it may be seen as an object of the present disclosure to provide a heat exchanger that solves the above mentioned problems of the prior art with poor energy efficiency and energy waste expressed through harmful heating of the heat exchanger itself instead of the flowing liquid which is the targeted subject of said heating.

As used herein, the term “energy efficiency” is meant to denote the percentage of the available heat capability of the fuel to the burner that is used for heating the liquid. In the context of the present disclosure, composite is to be understood as a solid material which is composed of two or more substances having different physical characteristics and in which each substance retains its identity while contributing desirable properties to the whole. Especially, the composite may be such as a fiber reinforced polymeric material. The disclosure can be advantageous for easing transport of the embodiment between adjacent areas. The disclosure can also be advantageous for manufacturing a vehicle with an integrated pressure washing system for cleaning of larger areas, such as large floor areas requiring powerful cleaning or outside, such as for cleaning of boardwalks or road surfaces.

It is appreciated that the same advantages and embodiments described herein and below for the first aspect apply as well for the second and third aspects. Further, it is appreciated that the described embodiments can be intermixed in any way between all the mentioned aspects.

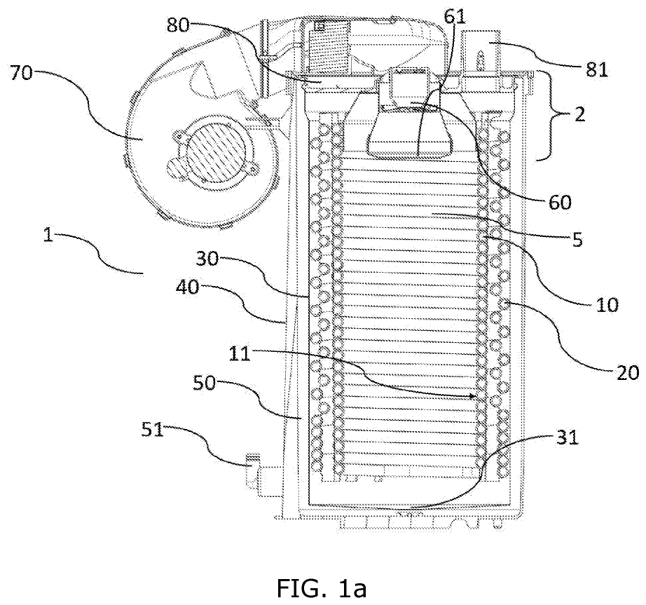

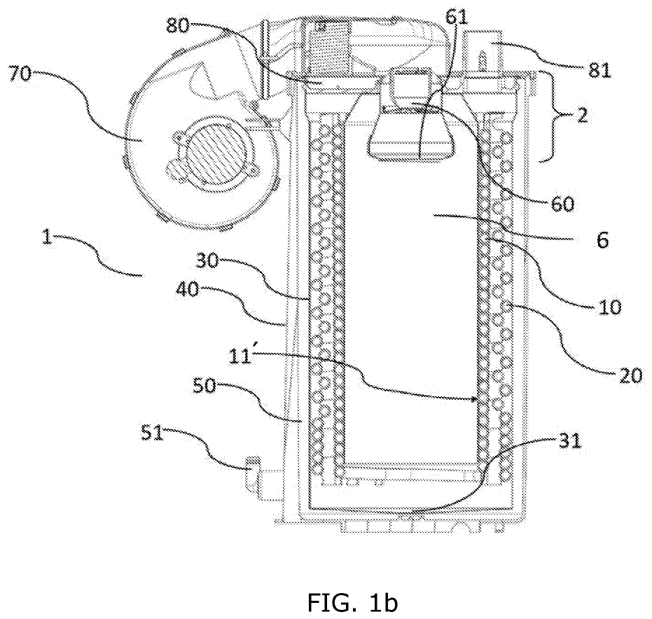

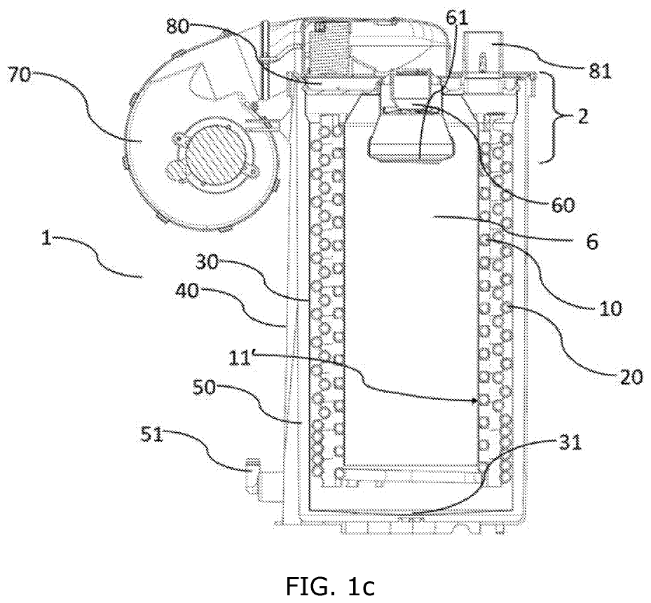

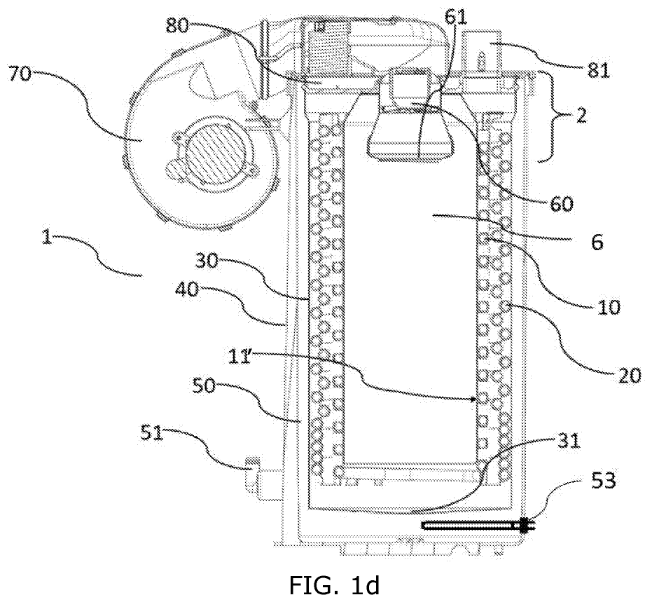

FIGS. 1a-1d all show embodiments, where coil 5 is manufactured by a pipe being wound into the desired shape. However, it is to be understood that the discloses coil 5 can be obtained with other configurations or methods of manufacturing.

FIG. 1a shows apparatus 1 with coil 5 arranged inside internal housing 30, said coil 5 comprising first and second layer of windings 10 and 20 and in which first layer of windings 10 is arranged inside second layer of windings 20. In the embodiment shown in FIG. 1a, first layer of windings 10 is tightly wound so as to form barrier 11 and second layer of windings 20 are wound at least partly, in a staggered pattern. At top portion 2 of apparatus 1, burner unit 60 is arranged with nozzle 61 directed, parallel to barrier 11 of first layer of windings 10, towards bottom portion 31 of internal housing 30, in which coil 5 is arranged. In this embodiment, the flame from burner unit 60 will directly come into contact with first layer of windings 10, whereas barrier 11 formed by first layer of windings 10 will prevent the flame from direct contact with the second layer of windings. The flame or exhaust gasses will contact second layer of windings 20 after being redirected upwards on the outside of barrier 11. It should be noted, however, that first layer of windings 10 need not be wound so tightly so as to form a barrier all along first layer of windings 10. Some of the adjacent windings may be arranged with a gap (not shown in FIG. 1a). Thus, a smaller portion of the exhaust gasses entering into the space between the first and second layer of windings may be recirculated into the inner part of first layer of windings 10.

Burner unit 60 is further connected to ventilator 70 through lid 80, lid 80 providing a seal with both internal and external housing 30 and 40. Internal housing 30 is arranged inside external housing 40, with liquid reservoir 50 in between the two housings 30 and 40. Outlet 51 is mounted on external housing 40 and connected to liquid reservoir 50. At top portion 2 of apparatus 1, chimney 81 is mounted, connecting the inside of internal housing 30 to an outside environment through lid 80.

FIG. 1b shows an alternative to the embodiment shown in FIG. 1a. The embodiment in FIG. 1b differs from the one in FIG. 1a with respect to barrier 11′. In FIG. 1b, barrier 11′ is formed by metal tube 6 inserted inside first layer of windings 10, such that metal tube 6 prevents the flame from burner unit 60 from direct contact with first layer of windings 10 as well as second layer of windings 20. Rather, the flame and/or exhaust gasses are guided by the metal tube to bottom 31 of the internal housing 30, and the flame or exhaust gasses will then contact first and second layers of windings 10, 20 on the way outside barrier 11′ formed by metal tube 6.

FIG. 1c shows another alternative to the embodiments of FIGS. 1a and 1b. The embodiment in FIG. 1c has the same barrier 11′ formed by metal tube 6 as in FIG. 1b. However, the windings of the first layer 10 are spaced apart, such that the flame or exhaust gasses can effectively come into contact with first and second layers 10, 20 of windings on the way upwards on the outside of barrier 11′.

FIG. 1d shows yet another embodiment which is similar to FIG. 1c except for the addition of electric pre-heater 53, i.e. an electrically driven heater arranged to pre-heat the liquid in liquid reservoir 50. Pre-heater 53 may especially be switched on and off by means of a controller, so that pre-heater 53 is used in periods, where burner unit 60 is not active. Thus, the liquid in liquid reservoir 50 can be electrically pre-heated e.g. to obtain a target temperature of the liquid in liquid reservoir 50, thereby allowing the target temperature, e.g. around 20° C., to be obtained even if burner unit 60 has not been used for a period of time. This allows a fuel efficient operation of the apparatus even under conditions, where the liquid in liquid reservoir 50 would otherwise be too cold for optimal heating, and further, a quicker start-up to full liquid temperature at the liquid outlet can be achieved, which is advantageous, e.g. when used in a high pressure washer.

In FIGS. 1a-1d it can be seen that bottom portion 31 is concave upwards so that condensed water, if any, may be led from the outer parts of bottom portion 31 towards the center part thereof, opposing burner unit 60. Even though the concave bottom portion 31 of FIGS. 1a-1d is shown as a rounded bottom portion, other upwardly concave shapes of bottom portion 31 are conceivable, such as angular, tapered towards the part of bottom portion 31 opposing burner unit 60 or shaped as a flat cone.

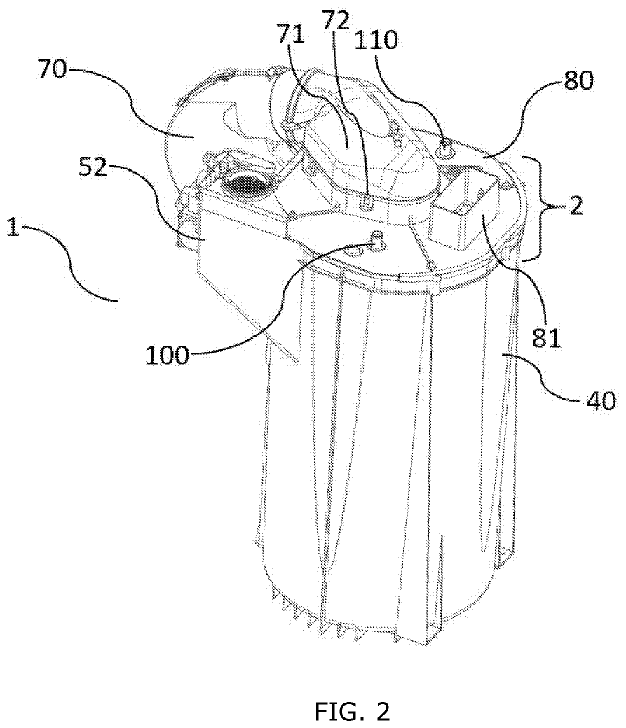

FIG. 2 shows apparatus 1, with lid 80 mounted to external housing 40 at top portion 2 of apparatus 1 and chimney 81 exiting lid 80. At the top of lid 80 coil inlet 100 and coil outlet 110 are arranged so as to receive and eject a liquid. On external housing 40 second liquid reservoir 52 is arranged, formed as part of external housing 40. Second liquid reservoir 52 functions as a water break tank to avoid pollution of potable water installations due to backflow of water from liquid reservoir 50. Second liquid reservoir 52 thus renders it possible for the apparatus for heating a flowing liquid to comply with the standard EN1717. Ventilator 70 is connected to lid 80 through ventilator housing 71 and said ventilator housing is attached to lid 80 with a plurality of snap-locks 72 and/or screws.

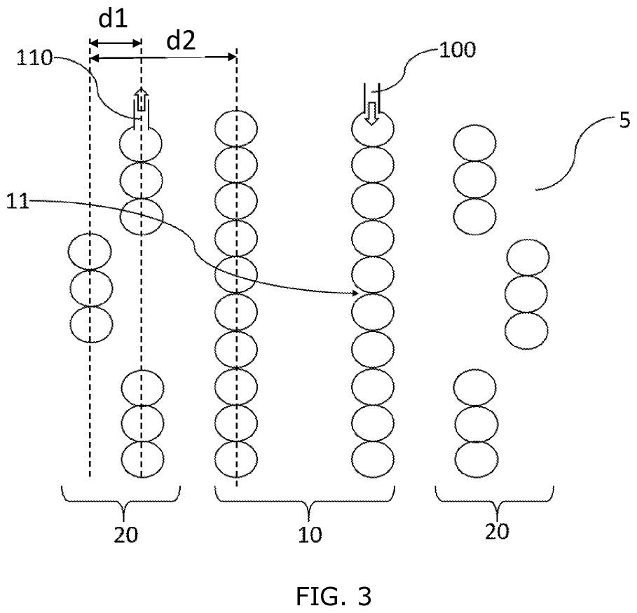

FIG. 3 is a schematic illustration of an embodiment of coil 5 in a cut side view. At the center, first layer of windings 10 is arranged, with second layer of windings 20 around first layer of windings 10. First layer of windings 10 are wound tightly together, forming barrier 11, and second layer of windings 20 are arranged in a staggered pattern. At the top of first layer of windings 10 coil inlet 100 is arranged and at the top of second layer of windings 20 coil outlet 110 is arranged. Especially, it is seen that second layer windings 20 are arranged with centerlines (dashed) through the pipes on two parallel axes being separated by distance dl which may be such as 1-50 mm. Further, first layer of windings 10 are also arranged with the centerlines (dashed) on a straight line, and especially distance d2 between this straight line of first layer of windings 10 and the outermost layer of the second layer of windings may be chosen to be within such as 20-100 mm.

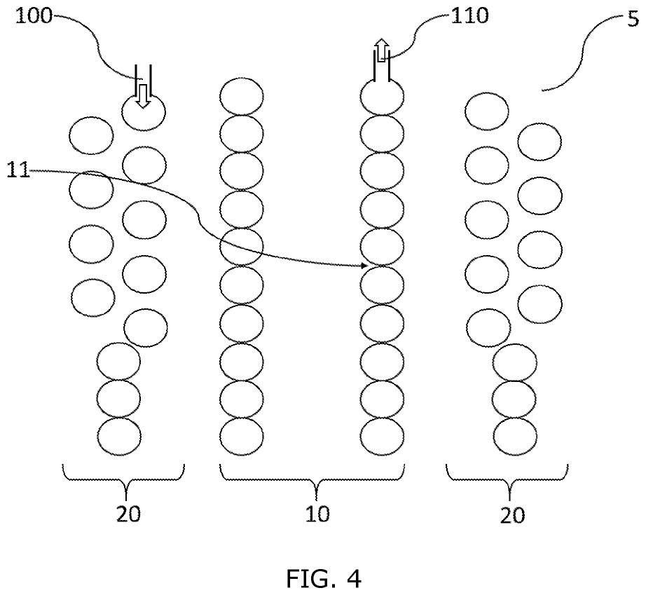

FIG. 4 is a schematic illustration of a second embodiment of coil 5 in a cut side view. At the center, first layer of windings 10 is arranged, with second layer of windings 20 around first layer of windings 10. First layer of windings 10 are wound tightly together, forming barrier 11, and second layer of windings 20 are arranged in a partly staggered pattern. At the top of first layer of windings 10 coil outlet 110 is arranged and at the top of second layer of windings 20 coil inlet 100 is arranged. Thus, in the embodiment shown in FIG. 4, the liquid to be heated is fed into second layer of windings 20 and exits coil 5 vifirst layer of windings 10. The embodiments of FIGS. 3 and 4 thus have opposite directions of flow through coil 5.

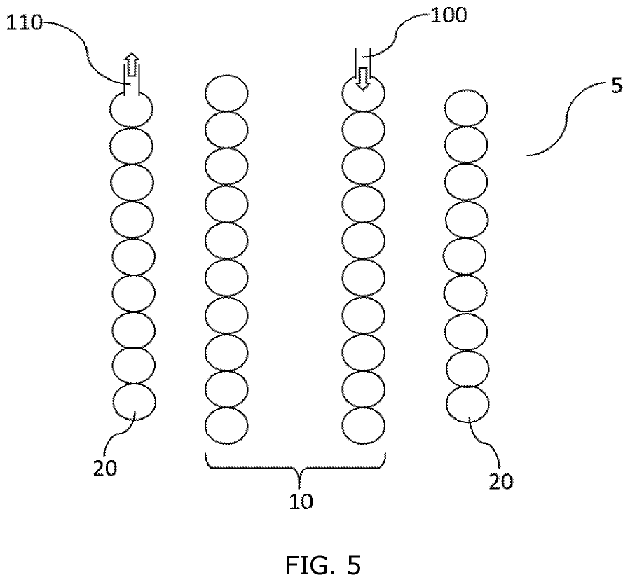

FIG. 5 is a schematic illustration of an embodiment of coil 5 in a cut side view. At the center, first layer of windings 10 is arranged, with second layer of windings 20 around first layer of windings 10. The windings of first layer of windings 10 are wound tightly together and the windings of second layer of windings 20 are arranged linear, parallel and similar to first layer of windings 10. In this embodiment, coil inlet 100 is arranged at the top of first layer of windings 10 and coil outlet 110 is arranged at the top of second layer of windings 20.

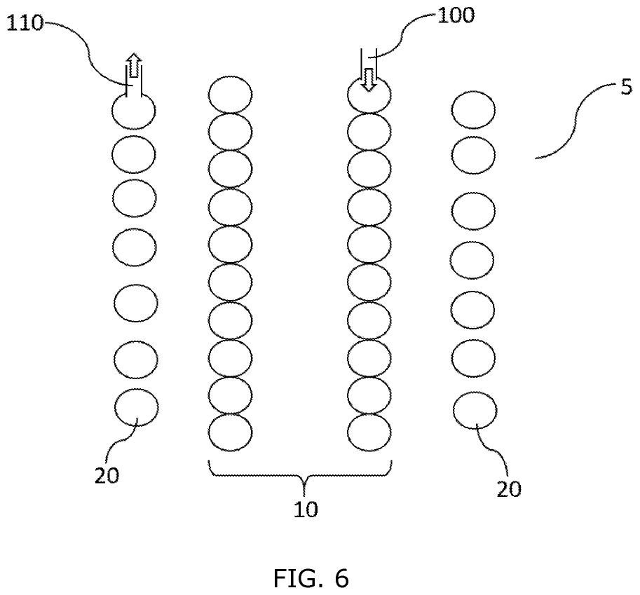

FIG. 6 is a schematic illustration of an embodiment of coil 5 in a cut side view. At the center, first layer of windings 10 is arranged, with second layer of windings 20 around first layer of windings 10. First layer of windings 10 are wound tightly together and second layer of windings 20 are arranged linear, spaced apart, parallel to first layer of windings 10. In this embodiment, coil inlet 100 is arranged at the top of first layer of windings 10 and coil outlet 110 is arranged at the top of second layer of windings 20.

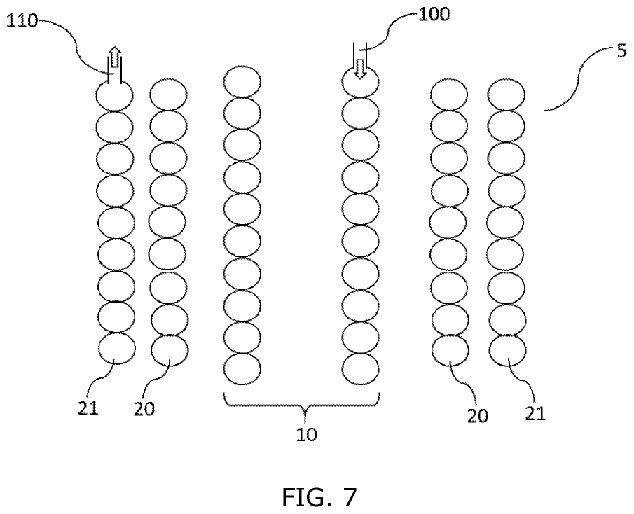

FIG. 7 is a schematic illustration of an embodiment of coil 5 in a cut side view. At the center, first layer of windings 10 is arranged, with second layer of windings 20 around first layer of windings 10. First layer of windings 10 are wound tightly together and second layer of windings 20 are arranged linear, parallel and similar to first layer of windings 10. Around second layer of windings 20, a third layer of windings 21 is arranged, linear and parallel to the first and second layer of windings 10, 20. In this embodiment, coil inlet 100 is arranged at the top of first layer of windings 10 and coil outlet 110 is arranged at the top of the third layer of windings 21.

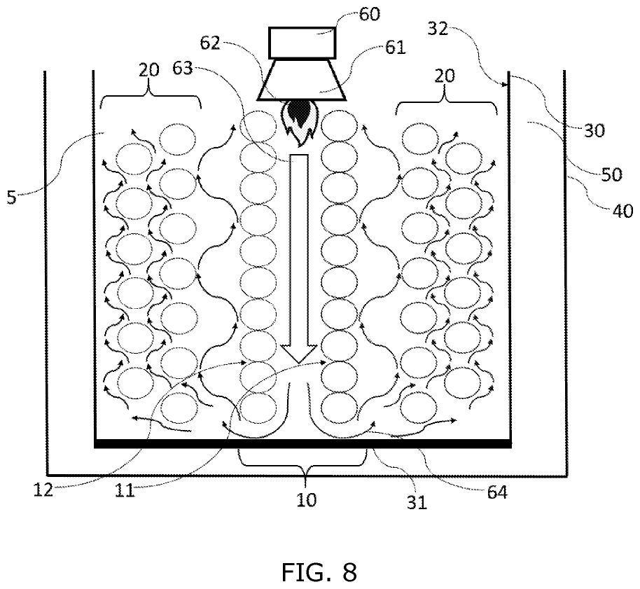

FIG. 8 is a schematic illustration of a third embodiment of coil 5 in a cut side view. Coil 5 is arranged inside internal housing 30, which is further arranged inside external housing 40, the two housings 30, 40 together forming liquid reservoir 50. At the center of the illustration, first layer of windings 10 is arranged, with second layer of windings 20 around first layer of windings 10. First layer of windings 10 are wound tightly together, forming barrier 11, and second layer of windings 20 are arranged in a partly staggered pattern. At a top portion of first layer of windings 10, burner unit 60 is arranged with nozzle 61, oriented downwards towards bottom portion 31 of internal housing 30, and flame 62 from nozzle 61 is directed 63, peripherally contained by barrier 11, towards bottom portion 31 and is further redirected around a bottom portion of first layer of windings 10 towards second layer of windings 20 and tortuously around said second layer of windings 20, illustrated by the plurality of arrows 64. Flame 62 is redirected towards second layer of windings 20 further affects an outer or opposite side 12 of barrier 11 made up of the internal layer of windings and inner wall 32 of internal housing 30. In FIG. 8, bottom portion 31 of internal housing 30 is shown as having a larger thickness than inner walls 32. This thicker bottom portion 31 shown in FIG. 8 indicates that bottom portion 31 is made of or comprises an insulating material, such as a mat of ceramic material, porcelain, firebrick or other earthenware or glass. It should be noted that the embodiment in FIG. 8 could also have an upwardly concave bottom portion 31 made of or comprising an insulating material.

It should be noted, that even though FIGS. 3-8 all show embodiments where first layer of windings 10 are wound so tightly so as to form a barrier all along the longitudinal direction of first layer of windings 10, viz. in the direction of flame 62 from burner unit 60, some of the adjacent windings may be arranged with a gap, e.g. in the lower part of first layer of windings 10. Thus, a smaller portion of the exhaust gasses entering into the space between the first and second layer of windings 10, 20 may be recirculated into the inner part of first layer of windings 10.

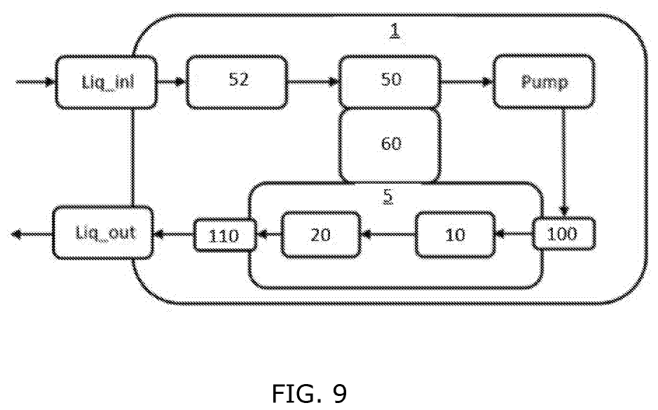

FIG. 9 is a schematic of the flow of liquid through an embodiment of the apparatus, e.g. suited for a high-pressure cleaner. The liquid flows into the apparatus from an external source, such as a water line, through a liquid inlet Liq_inl and from the liquid inlet Liq_inl to a second liquid reservoir 52, such as a cistern with a safety valve function. From second liquid reservoir 52 the liquid is guided to liquid reservoir 50. The liquid thus enters into liquid reservoir 50 via the inlet of liquid reservoir 50. The liquid in liquid reservoir 50 is at least partly heated by contact with a flame from burner unit 60. The liquid exits liquid reservoir 50 via an outlet of liquid reservoir 50 and flows to a pump which pressurizes the liquid before the liquid is fed into coil 5 via coil inlet 100. The pump pressurizes the liquid to a desired pressure level, such as above 50 bar, such as 50-600 bar. The liquid in coil 5 is further heated by contact with the flame from burner unit 60 and/or exhaust gasses therefrom. Coil 5 comprises first layer of windings 10 into which the liquid enters from coil inlet 100. From first layer of windings 10 the liquid flows through second layer of windings 20 in fluid connection with coil outlet 110. The liquid flows from coil outlet 110 out of the apparatus through a liquid outlet Liq_out, e.g. for connection to a hose connected to a spray device, in case of a high-pressure cleaner.

In an alternative embodiment, the flow between first layer of windings 10 and second layer of winding 20 may be reversed, hence the liquid flows from coil inlet 100 to second layer of windings 20, from second layer of windings 20 to first layer of windings 10 and from first layer of windings 10 to coil outlet 110, to further optimize the energy efficiency of the liquid heating apparatus.

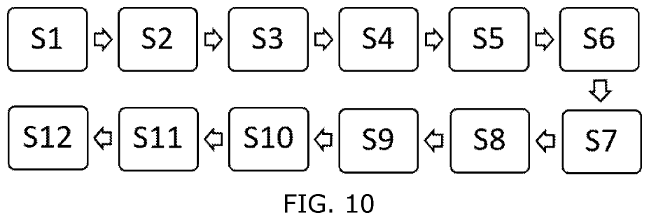

FIG. 10 is a flow chart of a method embodiment for heating a liquid received from a liquid inlet to a liquid outlet between two elements, such as a combusted fuel and a flowing liquid, the method comprising the following steps:

S1—providing burner unit 60 arranged to burn a fuel so as to generate flame 62,

S2—providing made of a pipe arranged for transporting the liquid between coil inlet 100 and coil outlet 110, coil 5 comprising first and second layer of windings 10, 20 wherein first layer of windings 10 are closely wound so as to form barrier 11, second layer of windings 20 are wound around first layer of windings 10 and coil outlet 110 is connected to the liquid outlet,

S3—providing external housing 40,

S4—providing internal housing 30,

S5—arranging coil 5 inside internal housing 30,

S6—arranging internal housing 30 at least partly inside external housing 40 thereby forming liquid reservoir 50 arranged to receive liquid from the liquid inlet,

S7—combusting fuel so as to heat the coil, the liquid within the coil and the liquid within the liquid reservoir,

S8—containing flame 62 from burner unit 60 peripherally by an inner part of first layer of windings 10,

S9—directing said flame 62 or exhaust gasses towards a bottom portion of internal housing 30 through the inner part of first layer of windings 10,

S10—redirecting flame 62 or exhaust gasses from the bottom portion of internal housing 30 towards a space between an outer part of first layer of windings 10 and inner wall 32 of internal housing 30 so as to allow flame 62 or exhaust gasses to contact all of: second layer of windings 20, inner wall 32 of internal housing 30, and the outer part of first layer of windings 10 facing second layer of windings 20,

S11—venting the gasses from the combusted fuel through a chimney, and

S12—providing a flow of liquid from the liquid inlet via liquid reservoir 50 to coil 5 so as to continuously heat liquid flowing through the apparatus between the liquid inlet and the liquid outlet through the combustion of fuel.

In short, the disclosure relates to an apparatus 1 and method for heating a liquid, such as water, flowing into and through said apparatus 1 from an associated liquid source. The apparatus comprises burner unit 60 and coil 5 arranged in internal housing 30, said internal housing 30 arranged inside external housing 40 dimensioned so as to form liquid reservoir 50 in between said two housings 30, 40 and wherein said burner unit 60 is arranged so as to direct a flame towards said coil 5. The liquid flows from said associated liquid source into the apparatus through a liquid inlet, into said liquid reservoir 50 and from said liquid reservoir 50 through coil 5 from a coil inlet to a coil outlet, and wherein coil 5 and internal housing 30 are arranged so as to, at least partly, direct the flame from burner unit 60 through a tortuous path, so as to ensure a high energy transfer from said flame to said liquid. This design can be advantageous for integration of the apparatus into a compact device, since the cool water surrounds the hot internal part of the apparatus. Thus, the external surface of the apparatus is cool enough to allow sensitive components to be placed close to external housing 40, and at the same time, the apparatus provides a high energy efficiency.

In a first aspect, the disclosure provides a liquid heating apparatus for heating a liquid received from a liquid inlet to a liquid outlet, the apparatus comprising:

a top portion with burner unit 60, wherein burner unit 60 is arranged to burn a fuel so as to generate a flame, where the flame is directed downwards,

a coil arranged for transporting the liquid between a coil inlet and a coil outlet, said coil comprising at least a first and a second layer of windings, wherein the second layer of windings are arranged around first layer of windings 10 and the coil outlet are connected to the liquid outlet,

an external housing,

an internal housing arranged at least partially within the external housing,

Wherein the apparatus is arranged to be in a substantially upright position during operation, wherein the coil is arranged inside the internal housing, wherein a compartment between the internal housing and the external housing serves as a liquid reservoir, so that liquid surrounds at least a part of the internal housing, wherein the liquid reservoir comprises an inlet connected to receive liquid from the liquid inlet, and an outlet connected to the coil inlet, wherein the flame from burner unit 60 is peripherally contained by an inner part of first layer of windings 10 of the coil, wherein the flame or exhaust gases are being directed downwards within first layer of windings 10 towards a bottom portion of the internal housing, and wherein the flame or exhaust gases are redirected from said bottom portion towards a space between first layer of windings 10 and an inner wall of the internal housing so as to allow the flame or exhaust gases to contact all of: the second layer of windings, the inner wall of the internal housing, and first layer of windings 10. The bottom portion of the internal housing is a bottom wall of the internal housing. At least some part of the bottom wall is the physically lowest part of the internal housing. Preferably, the internal housing and the bottom portion thereof are essentially rotationally symmetrical.

A longitudinal axis of the liquid heating apparatus extends through the internal housing and through the external housing, typically coinciding with or at least parallel to the center axis of first layer of windings 10 and the second layer of windings. In the figures, the longitudinal axis of the liquid heating apparatus is vertical. As used herein, the term “substantially upright position” is meant to denote that the longitudinal axis of the liquid heating apparatus is offset less than 15°, preferably less than 12° and more preferably less than 10° from vertical. When the apparatus is arranged to be in a substantially upright position, it is avoided that liquid from the liquid reservoir spills over the top of the liquid reservoir.

The disclosure can be advantageous for obtaining an increased efficiency of the energy supplied to the apparatus for heating the liquid, such as water, as the liquid, such as water, surrounding the internal housing is heated through two steps: firstly the liquid is heated while flowing through the liquid reservoir so as to increase the temperature of said liquid before it reaches the coil and wherein the liquid is further heated. Instead of wasting energy on unintentionally heating the external housing, the residual energy from the flame or exhaust gasses heating the coil is used to pre-heat the liquid flowing towards the coil through the wall of the internal housing. A derived advantage of the reduced heating performed on the external housing from burner unit 60 is a reduced demand for heat-resistant materials used for external components and reduced heat shielding of any heat-sensitive components on or near the apparatus. A further advantage of a higher utilization of the heat from the burner is the possibility of integrating all of the relevant components in one housing, further saving resources for materials, manufacturing and assembly.

In the context of the present disclosure, the residual energy is to be understood as the energy released from the combustion of fuel, which is not initially transferred from the flame or exhaust gasses to the coil but, such as the heated gasses from combustion and heat from the flame which comes into contact with the inner wall of the internal housing, hence transfers heat from said flame to said inner wall and further, to the liquid contained in the liquid reservoir.

In a pressure washer using heated water, the increased energy efficiency of the heat exchanger enables the manufacturer to create a more compact apparatus, suitable to use in smaller areas and furthermore, less resources will be spent on heat shielding the external surfaces of the apparatus to ensure the safety of an adjacent operator of said pressure washer.

It should be understood that when a high energy efficiency is obtained, e.g. an energy efficiency of 94%, 95%, or even higher, the exhaust gases of burner unit 60 may reach the dewpoint and condensed water may form within the internal housing. When the flame or exhaust gases of burner unit 60 is/are directed towards a bottom portion of the internal housing, the flame and/or exhaust gases assist in evaporating or vaporizing the condensed water so that it may leave the liquid heating apparatus together with the exhaust gases. This is due to the fact that the bottom portion, towards which the flame and/or exhaust gases is/are directed, will be the hottest part of the internal housing. The term “bottom portion” of the internal housing is meant to denote that this bottom portion is positioned lower than the burner. The bottom portion of the internal housing is at least substantially the lowest part of internal. It is advantageous that any condensed water is evaporated and leaves the liquid heating apparatus together with the exhaust gases, in that a drain for draining condensed water is thus not necessary. This is in particular advantageous if the apparatus is a mobile apparatus.

In an embodiment, the bottom portion is shaped to collect condensed water in a portion thereof opposing burner unit 60. In an embodiment, the bottom portion is concave upwards. The bottom portion may thus be rounded or angled towards the portion facing burner unit 60. Preferably, the bottom portion is rotational symmetrical and the portion facing burner unit 60 is a center or central part of the bottom portion.

Hereby, the bottom portion becomes an evaporation zone since water condensed on the inner wall of the internal housing or on the windings is led to the bottom portion of the internal housing by the influence of gravity and is assembled at a part of the bottom portion opposing burner unit 60 by means of the shape of the bottom portion. Thereby, the flame and/or exhaust gases from the burner is/are directed towards the part of the bottom portion at which the condensed water, if any, assembles, and the heat of the flame and/or exhaust gases facilitates the evaporation of condensed water. Thus, condensed water is evaporated and leaves the internal housing together with the exhaust gases.

In an embodiment, an insulating material, such as a mat of ceramic material, porcelain, firebrick or other earthenware or glass, may be positioned at the bottom portion. Alternatively, the bottom portion of the internal housing is of ceramic material, porcelain, firebrick or other earthenware or glass. By arranging a heat-insulating material at or as the bottom portion of the internal housing, condensed water is still able to flow into the bottom portion, but because of the heat-storing capacity of this bottom portion is may be heated up so much that it then heats and evaporates the condensate that runs into the bottom portion.

In an embodiment, first layer of windings 10 is closely wound so as to form a barrier. In the context of the present disclosure, the term “barrier” is to be understood as a formation or structure substantially impenetrable to the flame ejected from burner unit 60. In this embodiment, the barrier is thus formed by first layer of windings 10 which are wound closely so as to form a barrier to prevent direct contact between the flame and the second layer of windings. In an alternative embodiment, the barrier is formed by a barrier element, e.g. a metal element. Especially, such barrier element may be a metal tube arranged on the inside of first layer of windings 10 which is configured to either completely or at least partially prevent the flame from direct contact with the inner part of first layer of windings 10, thus hindering at least partially the flame or exhaust gasses from direct contact with first layer of windings 10 until the flame or exhaust gasses contact all of the first and second windings as well as an inner part of the internal housing after being guided in the opposite direction away from bottom part of the internal housing.

In an embodiment of the disclosure, the external housing is formed by a second coil around the internal housing, e.g. a tightly wound coil, and wherein the second coil is connected to the liquid inlet and the coil inlet, providing flow between the two parts and obtaining heat from an external wall of the internal housing, pre-heating the liquid flowing through said secondary coil before the liquid flows into the coil, i.e. the primary coil which is directly heated by the flame.

In an advantageous embodiment of the disclosure, the second layer of the coil is arranged with at least a part of the windings configured to form an open pattern to allow the flame or exhaust gasses to enter spaces between the windings, so as to provide optimal contact between the flame of exhaust gasses for efficient heat transfer to the liquid inside the coil. Especially, the second layer of windings may be arranged, at least partly, spaced apart in a staggered pattern so as to enable the flame to engulf and whirl through the pattern of second windings, thereby maximizing the surface area of the second layer of windings being affected by the flame so as to optimize the heat transfer from the flame to the coil.

In another embodiment of the disclosure, the coil comprises at least a third layer of windings arranged around the second layer of windings, which is arranged around first layer of windings 10, so as to further optimize the energy efficiency of the liquid heating apparatus, hence, optimizing the transfer of heat from the flame to the coil.

In a preferred embodiment of the disclosure, the flame, when redirected from the bottom portion of the internal housing is tortuously directed through the staggered pattern of the second layer of windings positioned between an outward area of first layer of windings 10 and the inner wall of the internal housing so as to further utilize the heat from the flame and increase the energy transfer from the flame to liquid intended for being heated.

The coil may be configured, so that the windings of the first layer form a straight line, e.g. a straight line parallel with a center axis through the internal housing. Alternatively, the windings of the first layer form a curved or wave shaped pattern.

In preferred embodiments, the second layer of windings extend within a distance of 10 cm, such as within 8 cm, such as within 5 cm, measured along a line perpendicular to an axis through a center of the liquid heating apparatus. In some embodiments all of the first and second layer of windings, and possibly further layer of windings of the coil, extend within a distance of 20 cm, such as within 15 cm, such as within 10 cm, measured along a line perpendicular to an axis through a center of the liquid heating apparatus.

The coil windings of the second layer of the coil may be arranged with at least a part of the windings configured to form an open pattern to allow the flame or exhaust gasses to enter spaces between the windings. Especially, at least a part of the second layer is arranged with the windings configured so that the windings form two parallel straight lines. Especially, centerlines through the windings may be separated by a certain distance, e.g. 1-100 mm, such as 1-50 mm, such as 1-20 mm, such as 2-10 mm. Specifically, a lower part of the second layer may comprise a plurality of windings forming a barrier, whereas the upper part of the second layer form two parallel straight lines where centerlines are separated by a certain distance, e.g. 1-100 mm, such as 1-50 mm, such as 1-20 mm, such as 2-10 mm. In some embodiments, the second layer is arranged with at least a part of the windings configured to form three or more straight lines, e.g. parallel lines.

In a preferred embodiment, the coil is formed from a pipe, such as a metal pipe e.g. a steel pipe, so as to ensure a uniform flow of liquid through said pipe, while also ensuring a sufficient heat conduction between the flame, the pipe and the liquid flowing inside the pipe. The coil is preferably manufactured by winding the pipe into the desired shape. The pipe may have a circular cross section, or another shaped cross section. The entire coil comprising first and second layers of possibly further layers, may be formed by winding one single pipe.

In another embodiment, the coil, or at least a part of the coil, is made from canals cast, molded, machined or by another method formed into an element, such as a radiator block arrangement, and wherein said canals are heated from the flame coming in contact with an outer surface of said canals, and hence heating the liquid flowing inside said canals. Especially, only first layer of windings 10 of the coil may be cast, molded, machined or by other method formed into an element. In other embodiments, both the first and second layer of windings of the coil are cast, molded, machined or by other method formed into an element.

In an embodiment of the disclosure, at least a bottom portion of the internal housing comprises an insulating layer, such as a ceramic layer, so as to withstand the flame from burner unit 60 and redirect the flame towards the second layer of windings, increasing the transfer of energy from the flame to the coil and hence, the liquid intended for heating. Especially, such insulating layer may be a fiber or metal mat.

In another embodiment of the disclosure, patches of insulating layers are placed within the internal housing for further optimizing the energy efficiency of the apparatus. Examples of insulating layers could be such as a firebrick element, such as lava rocks, such as fiber materials or such as metal materials, such as steel.

In an advantageous embodiment of the disclosure, burner unit 60 further comprises a nozzle and an air intake, suitable for burning a fossil fuel, e.g. a liquid fuel or a gaseous fuel. Specifically, the fuel may such as: diesel, butane, propane, kerosene, petrol, LPG, so as to increase the efficiency of combustion of fuel and reduce harmful emission gasses due to unburned fuel.

In an advantageous embodiment of the disclosure, the liquid temperature at the outlet of the liquid reservoir is heated relative to the inlet of the liquid reservoir by at least 1° C., such as at least 5° C., such as 5-40° C., or 5-30° C., or 5-20° C., so as to achieve an optimum inlet temperature of the liquid at the coil inlet relative to the size of the coil thereby optimally balancing the amount of combusted fuel relative to flowrate of said liquid through the coil obtaining the optimal outlet temperature of the liquid at the coil outlet, depending on the specific use of said liquid. It may be preferred to obtain a liquid temperature at the coil inlet being 5-60° C., or 10-60° C., or 20-60° C., or 10-50° C., or 20-50° C., however for other embodiments it may be preferred that the liquid temperature at the coil inlet is at least 60° C. or above, such as 80°-100° C.

Some embodiments comprise an electric pre-heater arranged to heat liquid in the liquid reservoir by means of applying an electric current from an external electric source, e.g. from a 230 V AC source or other electric source. The electric pre-heater can be controlled by a controller to switch on and off the electric pre-heater in response to a temperature sensor arranged to sense a temperature of the liquid in the liquid reservoir. Hereby, it is possible to maintain a target temperature of the liquid in the liquid reservoir, e.g. 5-60° C. or 10-40° C., even without burner unit 60 being active for a period of time, e.g. for a start up to obtain a minimum temperature of the liquid before starting the burner.

In an embodiment of the disclosure, the internal housing is manufactured from a ceramic, a composite or a metal, such as steel or other suitable alloys.

In preferred embodiments, the external housing is manufactured from a material comprising a polymer, such as polypropylene, polyethylene, acrylonitrile butadiene styrene, polycarbonate, polyamide or high impact polystyrene or other polymers. In some embodiments, the external housing is manufactured from a metal or a composite material. By using at least one material other than steel for the housing of the apparatus, the manufacturer can reduce resources spent on materials, and this is made available since the temperature handling for the external housing is relaxed due to the principle of the disclosure. It is an advantage that materials which can be casted or molded are useable for the external housing, since this opens up for providing any appropriate shape of the external housing and/or for producing the external housing with the a very low waste of material possible.

In preferred embodiments, the internal housing is manufactured from a metal or a ceramic, and the external house is manufactured from a non-metal material.

In an advantageous embodiment of the disclosure, the external housing is injection molded, such as in one single part or such as in two substantially identical parts so as to reduce manufacturing cost and time spent on manufacturing and assembly of the apparatus.

In some embodiments, the internal and/or external housing are manufactured from modular structures, enabling the manufacturer to increase the size of the apparatus, and hence, the size of the liquid reservoir, by adding more modules on top of each other and adjusting the height of the coil to the height of the internal housing, e.g. the modules may be glued together. This can be advantageous for reducing cost for molds when injection molding, as the cost of the mound is typically proportional to size.

In an advantageous embodiment, the apparatus further comprises an overflow port in the external housing connected to the liquid reservoir so as to allow excess liquid from said liquid reservoir to flow through said overflow port. An overflow port is an inexpensive method of ensuring overflow of liquid to sensitive components and prevent harmful pressure from building within the liquid reservoir. To prevent back flow from liquid reservoir to liquid inlet, a gap between liquid inlet and liquid level may be established, so as to hinder any liquid to flow back into the liquid source.

In a preferred embodiment of the disclosure, the apparatus further comprises a pressurizing device, such as a pump, suitable for pressurizing the liquid from the outlet of the liquid reservoir to the coil inlet. Thus, the pressuring device is in fluid connection with the outlet of the liquid reservoir and the coil inlet, arranged to receive the fluid from the outlet of the liquid reservoir, pressurize it and feed the pressurized fluid to the coil via the coil inlet. The pressurizing device is arranged for increasing the liquid pressure of at least 0.5 bar, such as 0.5-10 bar, such as 0.5-600 bar, such as 50-600 bar, such as at least 50 bar, such as 100 -400 bar or such as 150-350 bar.

In an alternative embodiment of the disclosure, the apparatus comprises a downstream pressurizing device, such as a pump, suitable for pressurizing the liquid downstream from the coil outlet. Thus, the downstream pressurizing device is arranged for pressurizing the liquid from the coil outlet prior between the coil outlet and the liquid outlet or is arranged for pressurizing the liquid from the liquid outlet.

Depending on the use of an embodiment of the disclosure, such as a pressure washer, the requirements for pressure and temperature of the liquid, such as water, varies. In an example one type of pressure washers normally operate at between 5-60 bar and another type of pressure washer operates at 50-600 bar. It is to be understood that the present disclosure may be suitable for application with both types of pressure washers.

In an embodiment of the disclosure, the apparatus further comprises a chimney connected to the internal housing, so as to ventilate the combusted exhaust gas from burner unit 60 to an external environment and ensure appropriate disposal of said exhaust gasses.

In an advantageous embodiment of the disclosure, burner unit 60 and chimney is mounted on a lid serving as an upper cover of the internal housing, preferably a metal lid, said lid being supported by the internal housing and/or the external housing so as to ensure easy access and maintenance of burner unit 60 and internal mechanisms of the apparatus.

In an embodiment of the disclosure, the apparatus further comprises a motor driven ventilator arranged to provide air to an air intake of burner unit 60, wherein the ventilator is further arranged to blow air to cool the lid, such as by air from the ventilator being directed past an internal surface of the lid or such as by being directed past an internal protrusions of the lid, so as to cool said lid and prevent an operator from any harmful interactions with a hot lid.

In an advantageous embodiment of the disclosure, the lid comprises a plurality of protrusions on an internal surface, relative to the internal housing, protrusions such as heat sinks or fins, and wherein said protrusions are in contact with the liquid in the liquid reservoir, so as to transfer heat from the lid to said liquid. Transfer of heat from said lid to the liquid would further increase the energy efficiency of the apparatus.

In a preferred embodiment of the disclosure, the apparatus further comprises a second liquid reservoir connected between the liquid inlet and the inlet of the liquid reservoir, and wherein the second liquid reservoir comprises a mechanism for controlling one or more of:

liquid flow to the second reservoir from an associated source of liquid, and/or

liquid flow from the second reservoir to the liquid reservoir, and/or

liquid flow from the liquid reservoir to the coil.

This embodiment can be advantageous for ensuring a continuous flow of liquid from the second liquid reservoir to the liquid reservoir between the internal and external housing, if the flow from the liquid inlet to the second liquid inlet were to be periodically interrupted. Another advantage is the safety element built into the embodiment, in which flow from the coil outlet, emptying the coil and the liquid reservoir would stop and prevent harmful overheating of the internal components of the apparatus, should the liquid flow from the liquid inlet or the flow from the second reservoir to the liquid reservoir or the coil inlet be interrupted or flow into the reservoir at a slower rate than the flow from the coil outlet for a prolonged period.

In an embodiment of the disclosure, liquid flows from first layer of windings 10 towards the second layer of windings in the coil so as to arrange the coil inlet at first layer of windings 10 and arrange the coil outlet at the second layer of windings.

In another embodiment of the disclosure, the liquid flows in an opposite direction relative to the above mentioned embodiment, thus the liquid flows from the second layer of windings towards first layer of windings 10 in the coil so as to arrange the coil inlet at the second layer of windings and arrange the coil outlet at first layer of windings 10.

In an embodiment, the liquid reservoir has two or more separate liquid outlets arranged at different positions, and wherein a controllable mixing mechanism serves to mix liquid from the two or more separate liquid outlets of the liquid reservoir, so as to obtain a target temperature of liquid for entering the coil inlet.

In another embodiment of the disclosure, the apparatus further comprises an external liquid mixing element connecting the coil inlet to the liquid outlet of the liquid reservoir and at least a second source of liquid so as to adjust the temperature of the liquid entering the coil, ensuring optimal energy efficiency of the liquid heating apparatus.

In another embodiment of the disclosure, the external liquid mixing element comprises a reservoir for mixing two or more liquids of different temperatures.

In another embodiment of the disclosure, the external liquid mixing element comprises an electronic controller and one or more valves for regulating the flow of liquid from the liquid reservoir and the one or more secondary sources of liquid.

In an advantageous embodiment of the disclosure, the second liquid reservoir is mounted at a top portion of the apparatus, and the liquid, such as water, flows from the liquid inlet of the apparatus to the second liquid reservoir, from the second liquid reservoir into the liquid reservoir through the inlet of the liquid reservoir, from the liquid reservoir into the coil from the outlet of the liquid reservoir through the coil inlet and through the coil to the coil outlet so as to use gravity to ensure flow from the second liquid reservoir to the liquid reservoir.

In an embodiment of the disclosure, the apparatus further comprises a bottom portion and wherein the outlet of the liquid reservoir is arranged at a distance from the bottom portion, relative to a total height of said liquid reservoir, such as at a distance from the bottom portion from 1% to 60% of the total height of the liquid reservoir, such as from 3% to 50%, such as from 10% to 50%, or such as from 15% to 40%. The distance between the outlet from the liquid reservoir to the bottom portion of the liquid reservoir can be adjusted so as to design the apparatus for a desired target temperature of the liquid flowing through said outlet.

In an embodiment of the disclosure, the apparatus is horizontally arranged, with burner unit 60 mounted on a side portion of the apparatus with a central axis arranged substantially parallel to a horizontal axis and wherein the coil is wound around said horizontal axis so as to direct the flame in a substantially horizontal direction through the first winding layer of the coil, towards a side portion of the inner housing, and from said side portion redirecting the flame horizontally in an opposite direction towards the second winding layer of the coil.

In a preferred embodiment of the disclosure, the apparatus is vertically arranged, comprising a top portion wherein a lid is arranged at said top portion, with burner unit 60 arranged on said lid so as to direct the flame downwards through the internal housing and through the first winding layer of the coil, towards the bottom portion of said internal housing. The embodiment is preferably higher, relative to a cross section of the apparatus in which a vertical arrangement will have a smaller footprint and hence be easier to transfer between various positions. When the apparatus is vertically arranged, gravity will assist in making any condensed water, e.g. on some colder parts of the coil, fall down to the bottom portion of the internal housing. The relatively high temperature of this bottom portion of the internal housing assists in evaporating the condensed water. It should be noted, that the term “vertically arranged” is meant to denote that the apparatus has a substantial vertical orientation, in the sense that the center axis of the internal housing, viz. the longitudinal axis of the liquid heating apparatus, is substantial vertical.

In a preferred embodiment of the disclosure, the bottom portion of the internal housing has a drain. Through the drain, condensed water may be outlet from the bottom portion of the internal housing. Hereby, it is avoided that heat of burner unit 60 is used for evaporating condensed water at the bottom portion and the efficacy of the liquid heating apparatus is increased.

In an embodiment, the bottom portion of the internal housing has a drain opening. Hereby, condensed water collected in the bottom portion may be led out of the internal housing. This may be advantageous if the temperature of the heated liquid leaving the liquid heating apparatus is relatively low and quite a substantial amount of condensed water is created within the internal housing and is collected at the bottom portion thereof.

In a preferred embodiment of the disclosure, the total surface area of the coil is between 0.1-20 m², such as between 0.2-10 m² or such as between 0.5-5 m².

The cross-sectional area of the coil windings may be such as 1-1000 mm², such as 10-500 mm². Especially, the coil is made of pipes with a circular cross section, however the coil can in general be made of pipes or canals with a circular, elliptical, or other cross-sectional shape.

In an advantageous embodiment of the disclosure, the total volume of the liquid reservoir is0.1-100 L, such as 0.5-20 L, such as 1-10 L or such as 0.2-45 L so as to ensure a sufficient supply of liquid in case of a periodic disruption from the external supply and further to act as an energy storage obtaining and containing residual heat from burner unit 60.

In an embodiment of the disclosure, the total weight of the apparatus is less than 300 kg, preferably less than 100 kg and most preferably less than 50 kg so as to have a suitable weight relative to the intended use.

In an embodiment of the disclosure, the apparatus is configured for a liquid flow through the coil being 0.1-200 L/min., such as 0.1-100 L/min., such as 3-100 L/min, such as 5-100 L/min, such as 10-80 L/min or such as 0.1-70 L/min, such as 0.5-50 L/min. Preferably, the apparatus is designed to a liquid flow being suitable relative to the size of burner unit 60 and the intended use, e.g. for a high pressure cleaner or washer.

In an advantageous embodiment of the disclosure, the coil inlet and the coil outlet can be arranged both at the top and bottom portion of the apparatus due to the design of the internal housing and the coil, so as to optimize the heat transfer efficiency from burner unit 60 to the coil and from the coil to the liquid flowing through the coil. In some embodiments the coil inlet and coil outlet are arranged at the top portion of the apparatus. In some embodiments the coil inlet and coil outlet are arranged at the bottom portion of the apparatus. In some embodiments, the coil inlet and coil outlet are arranged at the opposite portion of the apparatus.

In an embodiment of the disclosure, the internal housing is substantially cylindrical. Alternatively, the internal housing may be conical, i.e. with a larger surface area at top portion relative to a bottom portion or such as with a larger surface area at bottom portion relative to a top portion. Likewise, the external housing may be substantially cylindrical, or alternatively conical, i.e. with a larger surface area at top portion relative to a bottom portion or such as with a larger surface area at bottom portion relative to a top portion. Especially, both of the internal and external housings may be cylindrical, or both may be conical. Especially, the internal housing may be symmetrically arranged within the external housing.

In an embodiment of the disclosure, the volume of the internal housing relative to the external housing has a ratio of 1:5, such as 1:2, such as 1:1.05 or such as 1:1.01 so as to ensure a sufficient volume of the liquid reservoir formed by the space in between the two housings.

In an embodiment of the disclosure, the piping used for the coil has an outside diameter between 1 mm and 100 mm, such as between 2 mm and 50 mm or such as between 5 mm and 20 mm so as to ensure a sufficient flowrate of liquid at a predetermined pressure.

In an embodiment of the disclosure, the coil has at least 5 windings, such as at least 10 windings, such as at least 20 windings, such as at least 50 windings, such as at least 100 windings, such as at least 500 windings so as to ensure a sufficient surface area of the coil and transfer rate of energy between the flame and coil, relative to the flow rate of the liquid through the coil and the burn rate of fuel from burner unit 60. In preferred embodiments, first layer of windings 10 has at least 5 windings, and the second layer of windings has at least 5 windings.

In an embodiment of the disclosure, the liquid inlet is connected to a water softening system, so as to remove calcium from the water before the water flows into the liquid heating apparatus, so as to prevent calcium build-up in the apparatus, such as in the liquid reservoir, such as in the pump or such as in the coil.

In a second aspect, the disclosure provides a device comprising an apparatus according to the first aspect, e.g. any of the preceding claims. A preferred device embodiment is one of: a portable pressure cleaner, a mobile pressure cleaner, a stationary pressure cleaner, a heat unit for connection to another devices, or a steam device, such as for providing steam for weed abatement. Especially, the device may be a high-pressure device, i.e. a device capable of providing a liquid pressure of such as 60 bar of more. In another embodiment, the device is a heat unit, e.g. a heat unit (e.g. a so-called hot box) arranged for connection to a pressure washer or cleaner.

A special device embodiment comprises a trolley, said trolley comprising:

a mount for the liquid heating apparatus, and

a source of fuel, such as a fuel tank, e.g. a detachable gas or diesel tank.

In an advantageous embodiment of the disclosure, the apparatus further comprises:

energy storing means,

water storing means, and

a propulsion mechanism,

so as to enable the trolley to be free from restraining hoses and/or wires, such as water hoses and power chords.

In a third aspect, the disclosure provides a method for heating a liquid received from a liquid inlet to a liquid outlet, the method comprising:

providing burner unit 60 arranged to burn a fuel so as to generate a flame,

providing a coil arranged for transporting the liquid between a coil inlet and a coil outlet, said coil comprising a first and a second layer of windings wherein first layer of windings 10 is arranged around first layer of windings 10 and the coil outlet is connected to the liquid outlet,

providing an external housing,

providing an internal housing,

arranging the coil inside the internal housing,

arranging the internal housing at least partly inside the external housing thereby forming a liquid reservoir arranged to receive liquid from the liquid inlet,

directing said flame towards a bottom portion of the internal housing,

redirecting the flame or exhaust gasses from the bottom portion of the internal housing towards a space between an outer part of first layer of windings 10 and an inner wall of the internal housing so as to allow the flame or exhaust gasses to contact all of: the first and second layer of windings, and the inner wall of the internal housing, and

providing a flow of liquid from the liquid reservoir to the coil so as to continuously heat flowing liquid in response to the combustion of fuel.

The method comprising arranging the coil, the external housing and the internal housing in a substantially upright position. Again, the term “substantially upright position” is meant to denote that the center axis of the coil, viz. the longitudinal axis of the external housing and of the internal housing, is offset less than 15°, preferably less than 12° and more preferably less than 10° from vertical

In a preferred embodiment of the disclosure according to the third aspect, the coil is made from a pipe, such as a metal pipe, so as to ensure simple manufacturing and low cost of the coil. Especially, one single pipe is wound into shape to provide the first, second, and optionally further, layers of windings.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A liquid heating apparatus for heating a liquid received from a liquid inlet to a liquid outlet, the apparatus comprising:
a top portion with a burner unit, wherein the burner unit is arranged to burn a fuel so as to generate a flame, wherein the flame is directed downwards;
a coil arranged for transporting the liquid between a coil inlet and a coil outlet, the coil comprising at least a first and a second layer of windings, wherein the second layer of windings are arranged around the first layer of windings and the coil outlet are connected to the liquid outlet;
an external housing;
an internal housing arranged at least partially within the external housing; and
wherein the apparatus is arranged to be in a substantially upright position during operation, wherein the coil is arranged inside the internal housing, wherein a compartment between the internal housing and the external housing serves as a first liquid reservoir, so that the liquid surrounds at least a part of the internal housing, wherein the first liquid reservoir comprises:
an inlet connected to receive the liquid from the liquid inlet, and;
an outlet connected to the coil inlet, wherein the flame from the burner unit is peripherally contained by an inner part of the first layer of windings of the coil, wherein the first layer of windings is configured to direct the flame or exhaust gases downwards toward a bottom portion of the internal housing, and wherein the flame or exhaust gases are redirected from the bottom portion toward a space between the first layer of windings and an inner wall of the internal housing so as to allow the flame or exhaust gases to contact all of:
the second layer of windings;
the inner wall of the internal housing; and
the first layer of windings.

2. The apparatus of claim 1, wherein the bottom portion is shaped to collect condensed water in a portion thereof opposing the burner unit.

3. The apparatus of claim 2, wherein the bottom portion is concave upwards.

4. The apparatus of claim 1, wherein the first layer of windings is closely wound so as to form a barrier.

5. The apparatus of claim 4, wherein the part of the second layer of windings are arranged spaced apart in a staggered pattern.

6. The apparatus of claim 1, wherein a barrier element is arranged within the inner part of the first layer of windings.

7. The apparatus of claim 1, wherein the second layer of the coil may be arranged with at least a part of the windings configured to form an open pattern to allow the flame or exhaust gasses to enter spaces between the windings.

8. The apparatus of claim 1, wherein the coil is formed from a pipe.

9. The apparatus of claim 1, wherein the internal housing is manufactured from ceramics or a metal, and the external housing is manufactured from a composite or a polymer.

10. The apparatus of claim 1, further comprising a pressurizing device, such as a pump, suitable for pressurizing the liquid from the outlet of the first liquid reservoir to the coil inlet.

11. The apparatus of claim 1, further comprising a downstream pressurizing device, such as a pump, suitable for pressurizing the liquid downstream from the coil outlet.

12. The apparatus of claim 1 further comprising a second liquid reservoir connected between the liquid inlet and the inlet of the first liquid reservoir, and wherein the second liquid reservoir comprises a mechanism for controlling at least one of:
liquid flow to the second liquid reservoir from an associated source of liquid;
liquid flow from the second liquid reservoir to the first liquid reservoir; and
liquid flow from the first liquid reservoir to the coil.

13. The apparatus of claim 1, configured to flow a liquid from the first layer of windings to the second layer of windings in the coil.

14. The apparatus of claim 1, configured to flow a liquid from the second layer of windings to the first layer of windings in the coil.

15. The apparatus of claim 1, further comprising a bottom portion and wherein the outlet of the first liquid reservoir is arranged at a distance from the bottom portion, relative to a total height of the first liquid reservoir, at a distance from the bottom portion from 1% to 60% of the total height of the first liquid reservoir.

14. The apparatus of claim 1, wherein the apparatus is vertically arranged and comprises a top portion wherein the burner unit is arranged, so as to direct the flame downwards through the internal housing and through the first winding layer of the coil toward the bottom portion of the internal housing.

15. The apparatus of claim 1, wherein the bottom portion of the internal housing comprises a drain opening.

16. A device comprising an apparatus of claim 1, wherein the device comprises at least one of a portable pressure cleaner, a mobile pressure cleaner, a stationary pressure cleaner, a heat unit for connection to another devices, and a steam device for weed abatement.

17. A method for heating a liquid received from a liquid inlet to a liquid outlet, the method comprising:
providing the burner unit arranged to burn a fuel so as to generate a flame;
providing a coil arranged for transporting the liquid between a coil inlet and a coil outlet, the coil comprising a first and a second layer of windings wherein the first layer of windings are arranged around the first layer of windings, and the coil outlet is connected to the liquid outlet;
providing an external housing;
providing an internal housing;
arranging the coil inside the internal housing;
arranging the internal housing at least partly inside the external housing thereby forming a liquid reservoir arranged to receive liquid from the liquid inlet;
directing the flame toward a bottom portion of the internal housing;
redirecting the flame or exhaust gasses from the bottom portion of the internal housing toward a space between an outer part of the first layer of windings and an inner wall of the internal housing so as to allow the flame or exhaust gasses to contact all of: the first layer of windings, the second layer of windings, and the inner wall of the internal housing; and
providing a flow of liquid from the liquid reservoir to the coil so as to continuously heat flowing liquid in response to the combustion of fuel.
